(19) United States
(12) Patent Application Publication
(10) Pub. No.: US 2021/0108754 A1
(43) Pub. Date: Apr. 15, 2021

(54) Tapping Saddle Assembly and Method for Establishing, Repairing, or Sealing Off a Connection Between Two Pipes

(71) Applicant: LMK Technologies, LLC, Ottawa, IL (US)

(72) Inventor: Rick Gage, Ottawa, IL (US)

(73) Assignee: LMK Technologies, LLC, Ottawa, IL (US)

(21) Appl. No.: 16/598,730

(22) Filed: Oct. 10, 2019

(51) Int. Cl. F16L 55/17; F16L 41/06

(52) U.S. Cl. CPC F16L 55/17; F16L 41/06

(57) ABSTRACT

A method and assembly for establishing or repairing the connection between a main pipe and a lateral pipe. The assembly includes a pipe saddle device having a curved plate with a first side and a second side. The second side of the curved plate is adapted to engage the main pipe. A gasket is combined with the second side of the curved plate and adapted to help create a seal between the curved plate and the pipe. The assembly further includes mechanical fasteners for securing the pipe saddle device to the pipe.

### BACKGROUND

The present invention relates to an apparatus and method for establishing, repairing, or sealing off a connection between two pipes, such as a buried sewer main pipe and lateral pipe.

Conventional sewer lines include a main pipe which extends along the street in a direction parallel to the street. Each house has a lateral pipeline that extends from the home and connects to the main pipeline. Sometimes the connection between the main pipe and the lateral pipe gets damaged, or sometimes it is desirable to connect a new lateral pipe to an existing main pipe. Devices referred to as saddles or tapping saddles are known in the pipe rehabilitation industry for such purposes. Tapping saddles include a curved plate positioned on the outer surface of the sewer pipe and extend at least partially around the sewer pipe to help secure the saddle to the pipe. A boss having a bore extends away from an aperture in the curved plate. The aperture in the curved plate is aligned with an aperture cut in the main pipe or with an aperture left in the main pipe when the lateral pipe was disconnected. The lateral pipe is connected to the boss to create or restore connection between the lateral pipe and the main pipe.

In some existing tapping saddle devices, the seal between the curved plate and the main pipe is prone to leakage or failure. This may result in ground water infiltrating the pipe and/or water and potentially sewage leaking from the pipe into the ground surrounding the pipe. Therefore, there is a need for an improved saddle device which helps create a fluid tight seal between the curved plate and the main pipe.

Therefore, a primary object, feature and/or advantage of the present invention is the provision of an improved method for establishing, repairing, or sealing off the connection between a main pipe and a lateral pipe.

A further object, feature and/or advantage of the present invention is a new apparatus and method for establishing, repairing, or sealing off the connection between a main pipe and a lateral pipe using an assembly having a compressible gasket between the curved plate and the main pipe.

A further object, feature and/or advantage of the present invention is a new apparatus and method for establishing, repairing, or sealing off the connection between a main pipe and a lateral pipe using an assembly having a hydrophilic or hydrophobic sealing gasket between the curved plate and the main pipe.

These and/or other objects, features and/or advantages of the present invention will become apparent with reference to the remainder of the specification and claims.

### SUMMARY

One aspect of the present invention includes an assembly for establishing or repairing the connection between two pipes such as between a first (main) pipe and a second (lateral) pipe. The assembly includes a pipe saddle device having a curved plate with a first side and a second side. The second side of the curved plate is adapted to engage the pipe along an arc of the outer surface of the pipe. The pipe saddle device also includes a boss extending upwardly from the curved plate about an aperture in the curved plate. A gasket, which may be pre-formed or formed from a bead of caulk or paste, extends around the aperture of the second side of the curved plate to help seal the curved plate to the first pipe. In the embodiments having a pre-formed gasket, the gasket may be attached to the second side of the curved plate mechanically or with an adhesive. The gasket may be made from any suitable compressible material, including a hydrophilic material, a hydrophobic material, and an absorbent material. A hydrophilic material is capable of expanding or swelling in response to being exposed to a liquid, such as water, and forms a seal between the second side of the curved plate and the main pipe. The assembly further includes one or more mechanical fasteners for securing the pipe saddle device to the pipe. The mechanical fastener may include a worm drive hose clamp, strap, bolts, screws, or the like. The mechanical fastener provides a first force against the first side of the pipe saddle device for securing the pipe saddle device to the pipe. In embodiments having a hydrophilic gasket, as the hydrophilic material expands upon its exposure to a liquid, the expanded hydrophobic material fills any space between the pipe saddle device and the main pipe and provides a second force to the second side of the curved plate. The mechanical fastener(s) hold the pipe saddle device against the pipe even as the second force pushes against the second side of the pipe saddle device therefore allowing the gasket to create a true compression seal. An adhesive material can also be disposed between the curved plate and the outer surface of the main pipe to assist in holding the curved plate on the pipe.

Another aspect of the present invention includes a method of establishing the connection between a main pipe and a lateral pipe. The method generally includes excavating the ground to expose a portion of the main pipe and the new lateral pipe adjacent to the main pipe, taking a pipe saddle device as described previously, attaching the pipe saddle device to the main pipe, securing the pipe saddle device to the main pipe using a mechanical fastener, cutting an access hole in the main pipe aligned with a boss bore formed by the boss of the pipe saddle device, and connecting the new lateral pipe with the boss to provide fluid communication between the main pipe and the lateral pipe. The pipe saddle device is mechanically secured to the main pipe by any suitable mechanical fastener. In embodiments where the gasket comprises a hydrophilic material, the mechanical fastener provides a first force against the first side of the pipe saddle device for securing the pipe saddle device to the pipe as the hydrophilic material expands upon its exposure to a liquid and provides a second force to the second side of the curved plate. As the hydrophilic material expands upon its exposure to a liquid, the expanded hydrophobic material fills any space between the pipe saddle device and the main pipe and provides a second force to the second side of the curved plate. The mechanical fastener(s) hold the pipe saddle device against the pipe even as the second force pushes against the second side of the pipe saddle device. An adhesive material can also be disposed between the curved plate and the outer surface of the main pipe to assist in holding the curved plate on the pipe.

Another aspect of the present invention includes a method of repairing the connection between a main pipe and a lateral pipe. The method generally includes excavating the ground to expose a portion of the main pipe and the existing lateral pipe connected to the main pipe, disconnecting the lateral pipe from the main pipe, taking a pipe saddle device as described previously, attaching the pipe saddle device to the main pipe, securing the pipe saddle device to the main pipe using a mechanical fastener, and reconnecting the lateral pipe with the boss to provide fluid communication between the main pipe and the lateral pipe. The pipe saddle device is mechanically secured to the pipe by any suitable mechanical fastener. The mechanical fastener provides a first force against the first side of the pipe saddle device for securing the pipe saddle device to the pipe. As the hydrophilic material expands upon its exposure to a liquid, the expanded hydrophobic material fills any space between the pipe saddle device and the main pipe and provides a second force to the second side of the curved plate. The mechanical fastener(s) hold the pipe saddle device against the pipe even as the second force pushes against the second side of the pipe saddle device. An adhesive material can also be disposed between the curved plate and the outer surface of the main pipe to assist in holding the curved plate on the pipe.

Another aspect of the present invention includes an assembly for repairing a crack, opening, or other damaged area in a main pipe or taking a lateral pipe out of service. The assembly includes a curved plate having a first side and a second side without an aperture in the middle. The second side of the curved plate is adapted to engage the pipe along an arc of the outer surface of the pipe at the area in need of repair or at the opening for a previously installed lateral pipe. A gasket is secured to the second side of the curved plate to help seal off an opening in the main pipe. The gasket is similar to the gasket described previously and may be in the shape of a ring or donut so that the gasket surrounds the opening in the pipe. The gasket may be made from any suitable compressible material, including a hydrophilic material, a hydrophobic material, and an absorbent material. A hydrophilic material is capable of expanding or swelling in response to being exposed to a liquid, such as water, and forms a seal between the second side of the curved plate and the main pipe. The pipe saddle device is mechanically secured to the pipe by any suitable mechanical fastener. The mechanical fastener provides a first force against the first side of the pipe saddle device for securing the pipe saddle device to the pipe. In embodiments where the gasket comprises a hydrophilic material, as the hydrophilic material expands upon its exposure to a liquid, the expanded hydrophobic material fills any space between the pipe saddle device and the main pipe and provides a second force to the second side of the curved plate. The mechanical fastener(s) hold the pipe saddle device against the pipe even as the second force pushes against the second side of the pipe saddle device. An adhesive material can also be disposed between the curved plate and the outer surface of the main pipe to assist in holding the curved plate on the pipe.

Another aspect of the present invention includes a method of repairing a crack or opening in a main pipe or taking a lateral pipe out of service. The method generally includes excavating the ground to expose a portion of the main pipe and the lateral pipe and/or the opening in the main pipe, disconnecting the lateral pipe from the main pipe (in embodiments where the lateral is being taken out of service) to leave an opening in the main pipe, taking a pipe saddle device as described in the previous paragraph, attaching the pipe saddle device to the main pipe with the gasket surrounding the opening, securing the pipe saddle device to the main pipe using a mechanical fastener. The pipe saddle device is mechanically secured to the pipe by any suitable mechanical fastener. The mechanical fastener provides a first force against the first side of the pipe saddle device for securing the pipe saddle device to the pipe. In embodiments where the gasket comprises a hydrophilic material, as the hydrophilic material expands upon its exposure to a liquid, the expanded hydrophobic material fills any space between the pipe saddle device and the main pipe and provides a second force to the second side of the curved plate. The mechanical fastener(s) hold the pipe saddle device against the pipe even as the second force pushes against the second side of the pipe saddle device. An adhesive material can also be disposed between the curved plate and the outer surface of the main pipe to assist in holding the curved plate on the pipe.

The present invention contemplates providing access to all kinds of pipelines, including, but not limited to mainline sewer pipelines, lateral sewer pipelines, gas pipelines, and potable water pipelines.

### BRIEF DESCRIPTION OF THE DRAWINGS

FIG. 1 is a side view of a pipe saddle device.

FIG. 2 is a perspective view of the second side of the pipe saddle device shown in FIG. 1.

FIG. 3 is a perspective partially exploded view of the pipe saddle device attached to a main pipe with mechanical fasteners.

FIG. 4 is a side view of the pipe saddle device attached to a main pipe with mechanical fasteners.

FIG. 5 is a perspective view showing the pipe saddle device attached to a cured CIPP liner of a rehabilitated main pipe.

FIG. 6 is a perspective view showing the pipe saddle device attached to a main pipe.

FIG. 7 is a section view of a pipe saddle device attached to a main pipe taken along lines 1-1 in FIG. 4.

FIG. 8 is a perspective view of a second side of another embodiment of a pipe saddle device.

FIG. 9 is a side view of the pipe saddle device of FIG. 8 combined with a main pipe to seal off an opening.

### DETAILED DESCRIPTION

For exemplary purposes only, the present invention is described in detail with reference to establishing, repairing, or sealing off the connection between a main pipe 16 and a lateral pipe 10. The present invention is equally applicable to as other types of pipe.

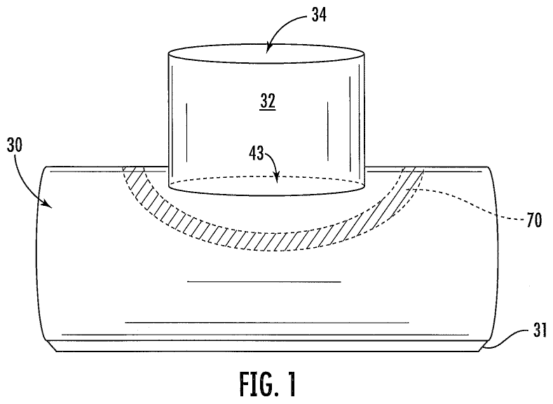

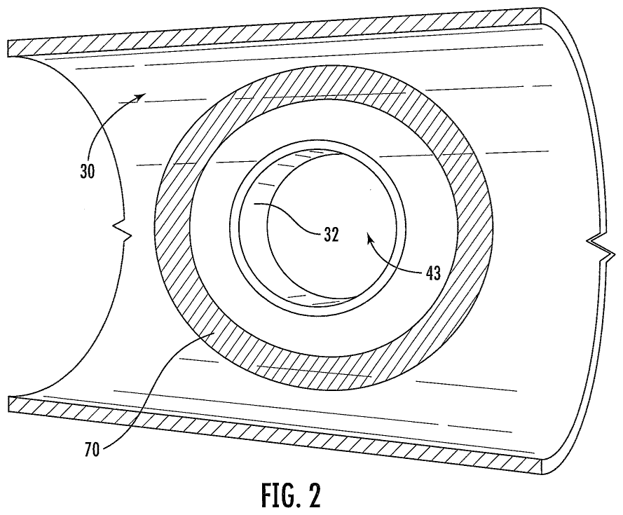

As best shown in FIGS. 1-2, an assembly having a pipe saddle device which includes a curved plate 30 with an aperture 43 therein and a boss 32. The aperture 43 is adapted to be aligned with an opening in the main pipe 16. The curved plate 30 has a first (top) side and a second (bottom) side. The boss 32 extends upwardly from the first side of the curved plate 30 and has a boss bore 34 extending there through and in communication with the aperture 43 in the curved plate 30. The second side of the curved plate 30 is adapted to engage the main pipe 16 along an arc of the outer surface of the pipe 16. A gasket 70 is combined with the second side of the curved plate 30 and extends around the aperture 43 in the curved plate 30 to form a seal between the curved plate 30 and the main pipe 16 around the opening in the main pipe 16.

In some embodiments, the curved plate 30 includes a concave surface having a radius of curvature less than the radius of curvature of the outer surface of the pipe 16 so that the curved plate 30 is biased against the outer surface of the pipe 16 when the curved plate 30 is expanded or flexed to engage the pipe 16. In these embodiments, because the curved plate 30 initially has a radius of curvature less than the radius of curvature of the outer surface of the pipe 16 in this embodiment, when the curved plate 30 is flexed and pushed down on top of the pipe 16, the curved plate 30 provides a pinching or clamping action around the outer surface of the pipe 16.

The gasket 70 may be made from any suitable material. In some embodiments the gasket 70 is a pre-formed compressible gasket 70 and in other embodiments the gasket 70 is a caulk or paste applied to the second side of the curved plate 30 before the curved plate 30 is pressed against the main pipe 16. The gasket 70 may be made from any suitable compressible material, including a hydrophilic material, a hydrophobic material, and an absorbent material. A hydrophilic material is capable of expanding or swelling in response to being exposed to a liquid, such as water, and forms a seal between the second side of the curved plate 30 and the main pipe 16. In the embodiments having a pre-formed gasket 70, the gasket may be attached to the second side of the curved plate 30 mechanically by staples or screws or by application of an adhesive. The gasket 70 may be a ring or doughnut shape for extending around the aperture 43 in the curved plate 30.

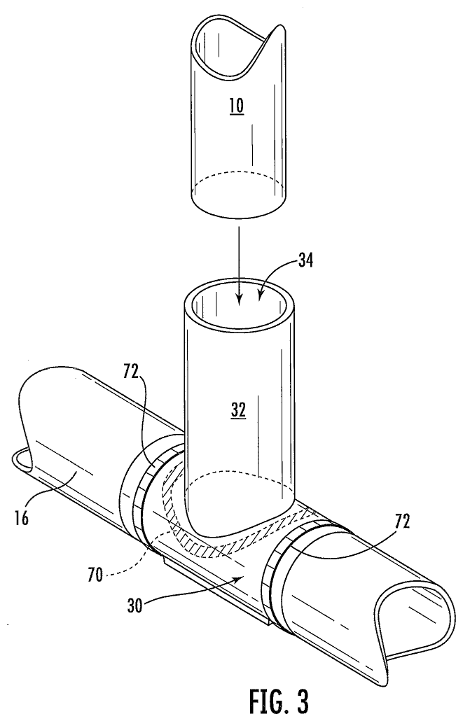

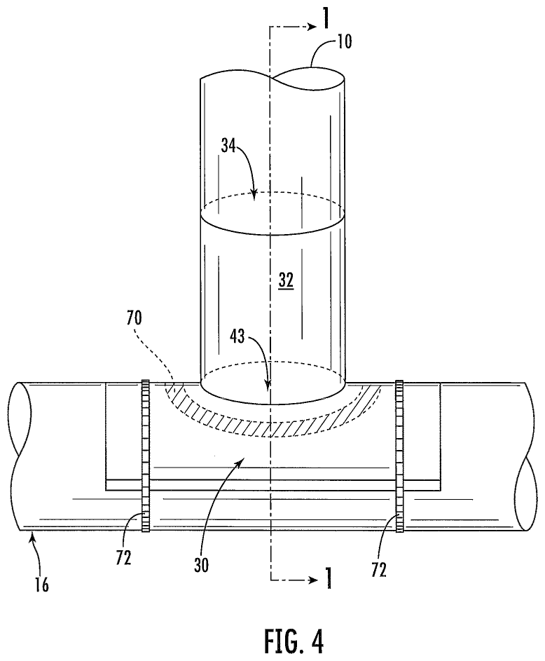

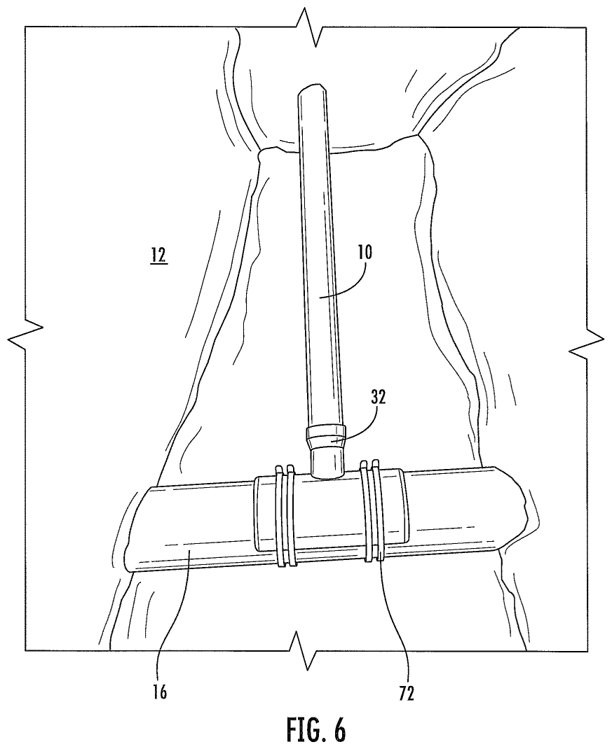

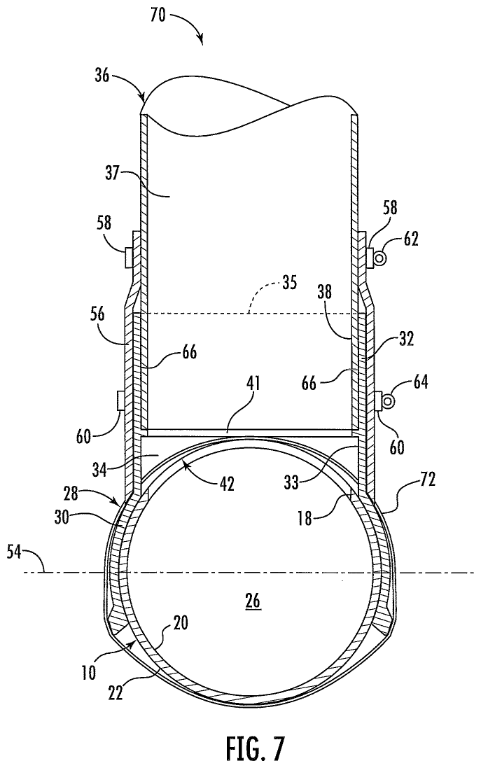

Referring to FIGS. 3-7, the pipe saddle device described above is used to connect a lateral sewer pipe 10 to a main sewer pipe 16 buried beneath the ground 12. The assembly further includes one or more mechanical fasteners 72 for securing the pipe saddle device to the pipe 16. Any suitable mechanical fastener 72 may be used, including a worm drive hose clamps, straps, bands, bolts, screws, or the like. The mechanical fasteners 72 provide a first force against the first side of the curved plate 30 for securing the pipe saddle device to the pipe 16. This first force helps ensure the pipe saddle device does not become significantly pushed away from the main pipe 16 in embodiments where the gasket is a hydrophilic material. In these embodiments, the hydrophilic material expands upon its exposure to a liquid and provides a second force to the second side of the curved plate 30. The mechanical fastener 72 provides a greater and opposing force which holds the pipe saddle device on the pipe 16 and allows the hydrophilic gasket 70 to fill the space between the curved plate 30 and the pipe 16 to create a fluid tight seal between the components. An adhesive material can also be disposed between the curved plate 30 and the outer surface of the main pipe 16 to assist in holding the curved plate on the pipe.

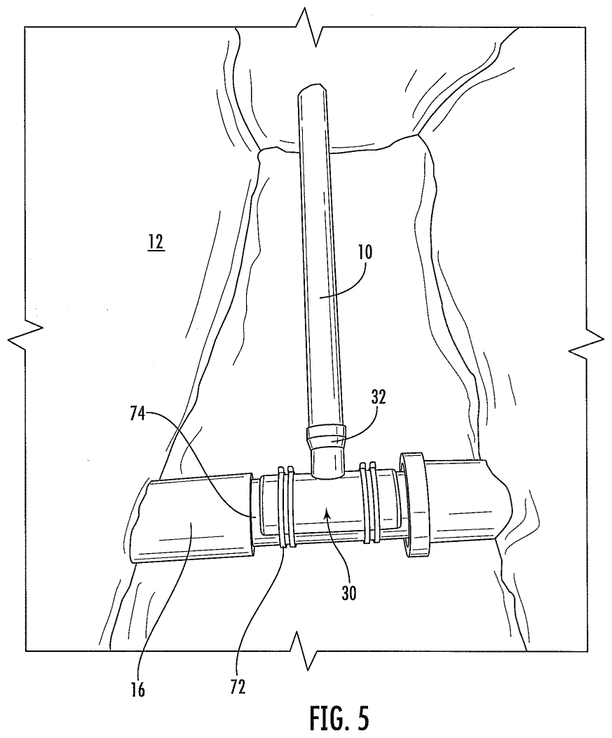

FIGS. 3, 4, 6, and 7 show one or more mechanical fasteners 72 used to secure the pipe saddle device to the outside of a main pipe 16 so that the aperture 43 in the curved plate 30 is in communication with the aperture in the main pipe 16. FIG. 5 shows an alternate embodiment wherein the pipe saddle device is combined with a cured and hardened Cured in Place Pipe (CIPP) main liner 74. In this embodiment, the CIPP main liner 74 has been previously positioned in the main pipe 16 to rehabilitate at least a portion of the main pipe 16. If the exterior of the main pipe 16 is crumbling, cracked, or is otherwise failing, the exterior of the main pipe 16 can be removed and cleared away near at the main/lateral junction leaving the previously positioned CIPP main liner 74 exposed and forming the main pipe conduit. The pipe saddle device can then be attached directly to the CIPP main liner 74 in the same manner described herein for attaching the pipe saddle device to the outer surface of the main pipe 16.

The assembly described above may be used to establish a new connection between a main pipe 16 and a lateral pipe 10. The method generally includes excavating the ground to expose a portion of the main pipe 16 and the new lateral pipe 10 adjacent to the main pipe 16, taking a pipe saddle device as described previously, attaching the pipe saddle device to the main pipe 16, securing the pipe saddle device to the main pipe 16 using a mechanical fastener 72, cutting an access hole in the main pipe 16 aligned with a boss bore 34 formed by the boss of the pipe saddle device, and connecting the new lateral pipe 10 with the boss 32 to provide fluid communication between the main pipe 16 and the lateral pipe 10. The lateral pipe 10 may be telescopically connected to the boss 32 by inserting one component 10, 32 within the other component 10, 32. The pipe saddle device is mechanically secured to the main pipe by any suitable mechanical fastener 72, including a worm drive hose clamp, straps, bolts, screws, or the like. The mechanical fastener 72 provides a first force for securing the pipe saddle device to the pipe 16. In embodiments where the gasket 70 is hydrophilic, the hydrophilic material expands upon its exposure to a liquid and provides a second force to the second side of the curved plate as further described above. The force of the mechanical fastener 72 is greater than the force of the hydrophilic gasket 70 to secure the pipe saddle device in is proper position.

The assembly disclosed above may be used to repair an existing connection between a main pipe 16 and a lateral pipe 10. The method generally includes excavating the ground to expose a portion of the main pipe 16 and the existing lateral pipe 10 connected to the main pipe 16, disconnecting the lateral pipe 10 from the main pipe 16, taking a pipe saddle device as described previously, attaching the pipe saddle device to the main pipe 16, securing the pipe saddle device to the main pipe 16 using a mechanical fastener 72, and reconnecting the lateral pipe 10 with the boss 32 to provide fluid communication between the main pipe 16 and the lateral pipe 10. The lateral pipe 10 may be telescopically connected to the boss 32 by inserting one component 10, 32 within the other component 10, 32. The pipe saddle device is mechanically secured to the pipe by any suitable mechanical fastener 72, including a worm drive hose clamp, straps, bolts, screws, or the like. The mechanical fastener 72 provides a first force for securing the pipe saddle device to the main pipe 16. In embodiments where the gasket 70 is hydrophilic, the hydrophilic material expands upon its exposure to a liquid and provides a second force to the second side of the curved plate as further described above. The force of the mechanical fastener 72 is greater than the force of the hydrophilic gasket 70 to secure the pipe saddle device in is proper position.

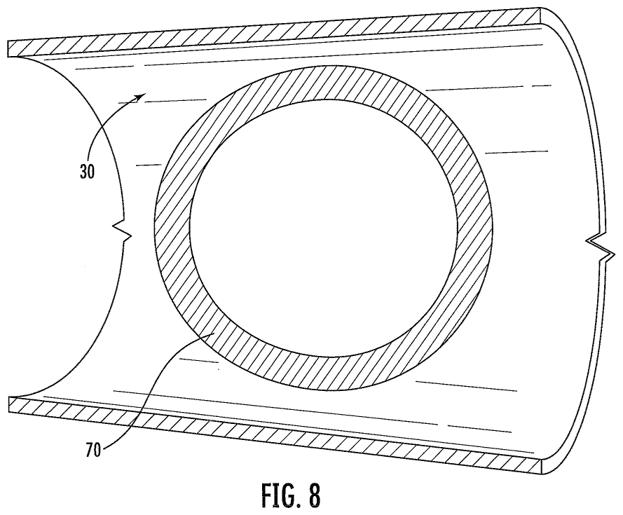

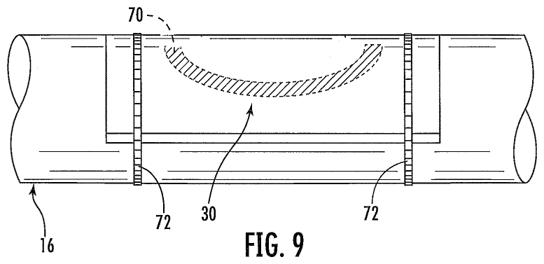

FIGS. 8 and 9 show another embodiment of the assembly which may be used to repair a crack or opening in a main pipe 16 or take a lateral pipe 10 out of service. The assembly includes a pipe saddle device having a curved plate 30 with a first side and a second side. The curved plate is a unitary piece without an aperture in the middle. The second side of the curved plate is adapted to engage the pipe 16 along an arc of the outer surface of the pipe 16. A gasket 70 is secured to the second side of the curved plate 30 to help seal off an opening in the main pipe 16. The gasket 70 is similar to the gasket 70 described in the previous embodiment and may be in the shape of a ring or donut having a diameter equal to or larger than a size of the opening in the main pipe 16 so that the gasket 70 does not cover the opening. In one embodiment the gasket 70 is large enough to have a flange portion that extends beyond the opening in the main pipe 16 on all sides to help create a seal between the gasket 70 and the outer surface of the pipe 16. The gasket 70 may be made from any suitable compressible material, including a hydrophilic material, a hydrophobic material, and an absorbent material.

The pipe saddle device is mechanically secured to the pipe by any suitable mechanical fastener 72, including a worm drive hose clamp, straps, bolts, screws, or the like. The mechanical fastener 72 provides a first force for securing the pipe saddle device to the pipe 16. This first force helps ensure the pipe saddle device does not become significantly pushed away from the main pipe 16 in embodiments where the gasket 70 is a hydrophilic material. In these embodiments, the hydrophilic material expands upon its exposure to a liquid and provides a second force to the second side of the curved plate 30. The mechanical fastener 72 provides a greater and opposing force which holds the pipe saddle device on the pipe 16 and allows the hydrophilic gasket 70 to fill the space between the curved plate 30 and the pipe 16 to create a fluid tight seal. An adhesive material can also be disposed between the curved plate 30 and the outer surface of the main pipe 16 to assist in holding the curved plate 30 on the pipe 16.

Another aspect of the present invention includes a method of repairing a crack or opening in a main pipe 16 or taking a lateral pipe 10 out of service using the assembly described with respect to FIGS. 8 and 9. The method generally includes excavating the ground to expose a portion of the main pipe 16 and the lateral pipe 10, disconnecting the lateral pipe from the main pipe (in embodiments where the lateral is being taken out of service) to leave an opening in the main pipe 16, taking a pipe saddle device as described with respect to FIGS. 8 and 9, attaching the pipe saddle device to the main pipe 16 with the gasket 70 around the opening in the pipe 16, securing the pipe saddle device to the main pipe 16 using one or more mechanical fasteners 72. The pipe saddle device is mechanically secured to the pipe by any suitable mechanical fastener 72 as described above.

In the drawings and specification there has been set forth a preferred embodiment of the invention, and although specific terms are employed, these are used in a generic and descriptive sense only and not for purposes of limitation. Changes in the form and the proportion of parts as well as in the substitution of equivalents are contemplated as circumstance may suggest or render expedient without departing from the spirit or scope of the invention as further defined in the following claims.

What is claimed is as follows:

1. An assembly for establishing or repairing the connection between a first pipe and a second pipe located below a surface of the ground, the first pipe having an outer surface, the assembly comprising:
a pipe saddle device having a curved plate with a first side and a second side, the curved plate having a boss extending therefrom about an aperture in the curved plate and adapted to engage the second pipe and the second side adapted to engage the outer surface of the first pipe; and
a gasket combined with the second side of the curved plate; and
a mechanical fastener adapted to secure the pipe saddle device to the first pipe.

2. The assembly of claim 1 wherein the gasket is a hydrophilic or hydrophobic material.

3. The assembly of claim 1 wherein the gasket is a hydrophilic paste.

4. The assembly of claim 1 wherein the gasket is a hydrophilic material capable of swelling in response to being exposed to a liquid.

5. The assembly of claim 1 wherein the mechanical fastener is one of a worm drive hose clamp, strap, bolt, or screw.

6. The assembly of claim 4 wherein the mechanical fastener provides a first force against the first side of the curved plate and upon exposing the hydrophilic gasket to a liquid the hydrophilic material provides a second force against the second side of the curved plate.

7. The assembly of claim 1 wherein the first pipe is a main pipe and the second pipe is a lateral pipe.

8. The assembly of claim 1 wherein the curved plate has a radius of curvature less than a radius of curvature of the first pipe to bias the curved plate against the first pipe.

9. The assembly of claim 1 wherein the second pipe is telescopically engaged with the boss.

10. The assembly of claim 1 wherein the gasket extends annularly around the aperture in the curved plate.

11. The assembly of claim 1 further comprising an adhesive material disposed between the second side of the curved plate and the outer surface of the first pipe.

12. A method of establishing or repairing the connection between a first pipe and a second pipe located below a surface of the ground, the method comprising:
excavating the ground to expose a portion of the first pipe and the second pipe;
taking an assembly comprising:
a pipe saddle device having a curved plate with a first side and a second side, the curved plate having a boss extending therefrom about an aperture in the curved plate and adapted to connect to the second pipe and the second side adapted to engage an outer surface of the first pipe;
a gasket combined with the second side of the curved plate; and
a mechanical fastener;
attaching the assembly to the first pipe by placing the second side of the curved plate about the outer surface of the first pipe so the gasket is between the curved plate and the first pipe; and
securing the curved plate to the first pipe with the mechanical fastener.

13. The method of claim 12 further comprising connecting the second pipe to the boss to provide fluid communication between the first pipe and the second pipe.

14. The method of claim 12 wherein the first pipe is a main pipe and the second pipe is a lateral pipe.

15. The assembly of claim 12 wherein the gasket extends annularly around the aperture in the curved plate.

16. The method of claim 12 further comprising:
applying an adhesive material to the second side of the curved plate before attaching the pipe saddle device to the first pipe; and
allowing the adhesive material to cure and harden after attaching the pipe saddle device to the first pipe.

17. The method of claim 12 wherein the mechanical fastener is one of a strap and a worm drive hose clamp and the securing step includes tightening the mechanical fastener around the first pipe and the pipe saddle device so that at least a portion of the mechanical fastener engages the first side of the curved plate.

18. An assembly for establishing or repairing the connection between a main pipe and a lateral pipe located below a surface of the ground, the assembly comprising:
a pipe saddle device having a curved plate with a first side and a second side, first side having a boss extending therefrom about an aperture in the curved plate and adapted to engage the second pipe and the second side adapted to engage an outer surface of the first pipe; and
a hydrophilic gasket combined with the second side of the curved plate about the aperture in the curved plate; and
a mechanical fastener securing the pipe saddle device to the first pipe.

19. The assembly of claim 18 wherein the mechanical fastener provides a first force against the first side of the curved plate and upon exposing the hydrophilic gasket to a liquid the hydrophilic material provides a second force against the second side of the curved plate.

20. The assembly of claim 18 wherein the mechanical fastener is one of a worm drive hose clamp, strap, bolts, or screws.

21. The assembly of claim 18 wherein the curved plate has a radius of curvature less than the radius of curvature of the pipe to bias the plate against the pipe.

22. The assembly of claim 18 wherein the lateral pipe is telescopically mounted to the boss.

23. An assembly for sealing an opening in a pipe having an outer surface and located below a surface of the ground, wherein the opening has a size, the assembly comprising:
a pipe saddle device having a curved plate with a first side and a second side, the second side adapted to engage the outer surface of the of pipe; and
a gasket combined with the second side of the curved plate and adapted to be placed over the opening; and
a mechanical fastener adapted to secure the pipe saddle device to the first pipe.

24. The assembly of claim 23 wherein the gasket is a hydrophilic or hydrophobic material.

25. The assembly of claim 23 wherein the gasket is a ring having a size larger than the size of the opening so the gasket surrounds the opening.

26. The assembly of claim 23 wherein the gasket is a hydrophilic material capable of swelling in response to being exposed to a liquid.

27. The assembly of claim 23 wherein the mechanical fastener is one of a worm drive hose clamp, strap, bolt, or screw.

28. The assembly of claim 26 wherein after the gasket is exposed to liquid, the mechanical fastener provides a first force against the first side of the curved plate and the hydrophilic material provides a second and opposing force against the second side of the curved plate.

29. The assembly of claim 23 further comprising an adhesive material disposed between the second side of the curved plate and the outer surface of the pipe.

30. A method of sealing an opening in a pipe located below a surface of the ground, wherein the opening has a size, the method comprising:
excavating the ground to expose the opening in the pipe;
taking an assembly comprising:
a pipe saddle device having a curved plate with a first side and a second side, the second side adapted to engage an outer surface of the pipe;
a gasket combined with the second side of the curved plate; and
a mechanical fastener;
attaching the assembly to the pipe by placing the curved plate about the outer surface of the first pipe so the gasket covers the opening; and
securing the curved plate to the pipe with the mechanical fastener.

31. The method of claim 30 further comprising:
applying an adhesive material to the second side of the curved plate before attaching the pipe saddle device to the pipe; and
allowing the adhesive material to cure and harden after attaching the pipe saddle device to the pipe.
